(19) United States
(12) Patent Application Publication
(10) Pub. No.: US 2019/0083977 A1
(43) Pub. Date: Mar. 21, 2019

(54) MICROFLUIDIC DEVICES HAVING A MICROCHANNEL WITH HYDROPHILIC COATING

(71) Applicant: Evonik Roehm GmbH, Darmstadt (DE)

(72) Inventors: Ghirmay SEYOUM, Egelsbach (DE); Anderea FRUTH, Wiesbaden (DE); Michael ENDERS, Dieburg (DE)

(73) Assignee: Evonik Roehm GmbH, Darmstadt (DE)

(21) Appl. No.: 16/084,801

(22) PCT Filed: Mar. 9, 2017
(86) PCT No.: PCT/EP2017/055517

§ 371 Date: Sep. 13, 2018

(30) Foreign Application Priority Data
Mar. 15, 2016 (EP) 16160349.3

(51) Int. Cl. B01L 3/00

(52) U.S. Cl. CPC B01L 3/502707; B01L 2300/165

(57) ABSTRACT

The present invention is in the field of medical diagnostics and microfluidics and primarily relates to a microfluidic device for the analysis of biological samples. The microfluidic device of the present invention comprises at least one microchannel, the inner surface of which is at least partially coated with a hydrophilic coating. This hydrophilic coating is located on top of the intermediate layer which, in turn, is located between the material of the inner surface of the microchannel and the hydrophilic coating.

### FIELD OF THE INVENTION

The present invention is in the field of medical diagnostics and microfluidics and primarily relates to a microfluidic device for the analysis of biological samples and environmental samples as well as in drug development.

The microfluidic device of the present invention comprises at least one microchannel, the inner surface of which is at least partially coated with a hydrophilic coating. This hydrophilic coating is located on top of the intermediate layer which, in turn, is located between the material of the inner surface of the microchannel and the hydrophilic coating.

In a particularly preferred embodiment, the microfluidic device of the present invention is composed of a monolithic body having at least one groove on its surface and a film attached to said surface. In this arrangement, the film acts as a top lid of the groove. Thus, the groove in combination with the film forms a microchannel. In this embodiment, the microchannel has a surface section which is formed by the surface of the film and extends along the entire path of the groove.

In a further preferred embodiment of the invention, the microfluidic device comprises at least two films, wherein at least one film has a groove on its surface and another film is attached to said surface thereby acting as a top lid of the groove. Thus, the groove on the surface of the first film in combination with the surface of the second film forms a microchannel. The entire inner surface of the microchannel is formed by the surface of the films. In this embodiment it is preferred that the entire inner surface of the microchannel is covered with the hydrophilic coating.

In yet a further preferred embodiment, the microfluidic device of the present invention comprises a plurality of stacked films and/or monolithic bodies forming a plurality of microchannels.

### PRIOR ART

In the recent decades, microfluidic devices have been increasingly applied for the analysis of various biological fluids, inter alia for blood analysis, enzymatic analysis, DNA analysis, proteomics etc. During such analysis, several assay operations such as detection, sample pre-treatment and sample preparation are typically carried out in a single microfluidic device. A particularly important application field for microfluidic devices is clinical pathology and diagnosis of diseases, where small biological samples of a patient are quickly analysed. Microfluidic devices per se are well-known to the skilled person and are described inter alia in WO 2004/029221 A2 and in the review article by Lee et al. (Lee et al. Sensors 2014, 14, 17008-17036) the entire disclosure of with is incorporated herein by reference.

GB 2462364 A describes a micro fluidic cartridge comprising: a channel for transporting a fluid from a first location in the micro fluidic cartridge to a second location in the microfluidic cartridge, the channel comprising a channel surface and a polymeric coating disposed on the channel surface. The polymeric coating or film may comprise a polymer with a hydrophobic portion that bonds to the channel surface and a hydrophilic portion that reduces surface tension within the channel.

WO 02/085185 A2 discloses a lateral flow in-vitro diagnostic device comprising a housing, means in the housing to introduce a sample to be assayed in said device, means in said housing for fluid collection, and a backing strip having spaced apart first and second ends, the improvement wherein the surface of said backing strip is hydrophilic in character.

The behaviour of fluids such as biological samples on a microscale differs from the common behaviour of fluids because factors such as surface tension, energy dissipation and viscosity start to dominate the system. In addition, many components of biological samples often show an undesired non-specific adsorption on the surface of the microchannel. For instance, absorption of entire cells of a biological sample, in particular of a blood sample, may render quantitative determination of such cells in a sample impossible, and even lead to a blockage of the microchannel.

Furthermore, biological samples to be analysed often contain organic solvents such as alcohols, glycerides or hydrocarbons which may sometimes interact with the material of a microchannel and, in extreme cases, lead to its swelling or dissolution.

Capillary forces also play an important role in transport of the biological sample through a microchannel. The biological samples are typically aqueous and therefore their transport through a microchannel requires that the inner surface of the microchannel is, at least partially, sufficiently hydrophilic.

Polymethyl methacrylate (PMMA) has recently found a wide-spread use in the field of microfluidic devices. However, uncoated PMMA is normally not sufficiently hydrophilic to enable a reliable transport of a sample to be analysed e.g. of a biological sample through a microchannel. For this reason, microfluidic devices made of PMMA usually employ hydrophilic coatings in the microchannels.

A common way to apply hydrophilic coatings refiles on a plasma or a corona treatment. However, the long-term stability of the resulting coatings is only limited to several weeks or, under optimal storage conditions, to several months. Therefore, microfluidic devices using this technology did not find a broad practical use.

M. Kitsara et al. (Microfluid Nanofluid, 2014, 16: 691-699) the entire content of which is incorporated herein by reference describe spin coating of hydrophilic polymeric films comprising polyvinyl alcohol (PVA) and (hydroxypropyl)methyl cellulose (HMPC). These hydrophilic films are reported to provide stable contact angles on PMMA substrates for more than 60 days. However, the curing of such hydrophilic coating needs to be carried out at a temperature of about 60° C. and takes at least 20 minutes. This renders such coating unsuitable for an industrial scale manufacturing processes such as roll-to-roll process which typically requires significantly shorter curing times.

### OBJECT OF THE INVENTION

Hence, the technical problem addressed by the present invention was to provide microfluidic devices with one or several microchannels having a sufficiently hydrophilic surface to allow a reliable transport of hydrophilic samples, in particular of biological and environmental samples in the microfluidic device. To ensure a high reliability of the device over a long period of time the hydrophilic coating needs to have high durability and a high resistance to aqueous media and to organic solvents such as alcohols, glycerides and hydrocarbons which are commonly present in biological and environmental samples.

Furthermore, it was important that the hydrophilic coating in the microfluidic device of the present invention shows substantially no interaction with the components of the biological samples such as cells, DNA, proteins or enzymes and, in particular, does not show any non-specific absorption.

To enable a cost-efficient production of the microfluidic device and, consequently, allow its wide-spread use in the medical diagnostics and environmental analysis, it is important that the hydrophilic coating and the hydrophilic device comprising the same can be manufactured in a simple and cost-efficient manner. For example, the microfluidic device should be ideally obtainable by simple and cost-efficient methods such as extrusion, injection moulding or hot-embossing and the hydrophilic coating should be suitable for large-scale processes such as roll-to-roll process.

### SUMMARY OF THE INVENTION

Surprisingly, the inventors found that the technical problems outlined above can be solved by providing a microfluidic device comprising at least one microchannel having an inner surface, the inner surface of which is at least partially coated with an intermediate layer directly applied to a material forming the inner surface of said microchannel and a hydrophilic coating located on top of the intermediate layer.

The microfluidic device of the present invention comprises at least one microchannel, wherein the inner surface of said microchannel is at least partially coated with an intermediate layer directly applied to a material of the inner surface of said microchannel and a hydrophilic coating located on top of the intermediate layer, and wherein

the hydrophilic coating consists of a hydrophilic material, the material of the inner surface of the microchannel is a hydrophobic material and the hydrophilic material, the hydrophobic material and material of the intermediate layer are substantially insoluble in water.

According to the present invention, the hydrophilic coating consists of a hydrophilic material and the material forming the inner surface of the microchannel consists of a hydrophobic material. Hence, the material of the hydrophilic coating is more hydrophilic than the material forming the inner surface of the microchannel. In other words, the contact angle formed by a water drop at 23±2° C. and relative humidity 50±5% on the surface of the hydrophobic material is higher than the contact angle formed by a water drop on the surface of the hydrophilic material. This design of the device allows an easier and more reliable transport of biological samples through the channel.

According to the present invention, the hydrophilic material, the hydrophobic material and the material of the intermediate layer are substantially insoluble in water. Therefore, they can be reliably used for the analysis of aqueous hydrophilic samples, in particular biological samples. The term “hydrophilic sample” as used herein refers to a sample comprising water, an alcohol such as ethanol or a mixture thereof.

A further aspect of the present invention is directed to an apparatus for analysis of biological and environmental samples, wherein the apparatus comprises a microfluidic device as described above.

In its further aspect, the present invention is related to use of a film, at least one surface of which is at least partially coated with an intermediate layer directly applied to the film material and a hydrophilic coating located on top of the intermediate layer, for the manufacturing of a microfluidic device, wherein the hydrophilic coating consists of a hydrophilic material, the material consists of a hydrophobic material and the hydrophilic material, the hydrophobic material and material of the intermediate layer are substantially insoluble in water.

In yet a further aspect, the present invention is related to process for the manufacturing of a microfluidic device, the process comprising a step of attaching a film having at least one surface which is least partially coated with an intermediate layer directly applied to the film material and an hydrophilic coating located on top of the intermediate layer to a monolithic body having at least one groove on its surface in such a way that at least one microchannel is defined by the groove in combination with the film,

wherein the hydrophilic coating consists of a hydrophilic material, the material consists of a hydrophobic material and the hydrophilic material, the hydrophobic material and material of the intermediate layer are substantially insoluble in water.

### DETAILED DESCRIPTION OF THE PREFERRED EMBODIMENTS

The inventors surprisingly found that colloid sized particles of silicon oxide, a metallic oxide, or a mixture thereof when located on an intermediate layer of a non-water-soluble and an essentially non-swellable polymer material containing at least one polar group, have an excellent compatibility with aqueous biological samples. Therefore, such coatings can be advantageously used for coating microchannels of a microfluidic device for the analysis of biological and environmental samples.

The coating used in the present invention can be applied with a substantially uniform thickness and therefore, undesired fluctuations of inner cross-area of the coated microchannels are avoided. This additionally increases reliability of the microfluidic device of the present invention.

In the present application the term microchannel is used in its common meaning and refers to a channel having an average diameter between 1.0 μm and 20 mm, preferably between 10 μm and 10 mm.

The term “insoluble” as used herein refers to a solubility lower than 1.0 g of the material in 1.0 l fluid (water), preferably lower than 0.001 g of the material, more preferably lower than 0.000001 g of the material in 1.0 l fluid (water). The term “non-swellable” in the present application refers to a swelling at saturation with water at 20° C. below 20% by volume, preferably below 10% by volume, more preferably below 2% by volume, particularly preferably below 0.2% by volume.

The cross-sectional area of the microchannel of the microfluidic device is not particularly limited as long as a reliable flow of the sample is ensured. Preferably, the average cross-sectional area of the microchannel is from 10 μm² to 4 mm², preferably from 40 μm² to 2 mm².

The shape of the cross-section of the microchannel is not limited as long as it allows a reliable flow of the sample through the channel. The microchannel may have a substantially circular cross-section, a rectangular cross section, a half circular cross-section, a triangular cross-section etc.

In the present application the terms hydrophobic material and hydrophilic material are used in their common meaning. Preferably, the hydrophobic material is chosen in such a way that water on a layer of neat hydrophobic material at 23±2° C. and relative humidity 50±5% forms a contact angle greater than 50°, more preferably greater than 60°, even more preferably greater than 70° and particularly preferably more than 80°. The hydrophilic material is chosen in such a way that water on a layer composed of neat hydrophilic material at 23±2° C. and relative humidity 50±5% forms contact angle smaller than 50°, more preferably smaller than 40°, even more preferably smaller than 30°, particularly preferable smaller than 20° and even more preferably below 10°.

According to the present invention, the hydrophilic material, the hydrophobic material and material of the intermediate layer are substantially insoluble in water. Thus, the solubility of these materials is lower than 1 g in 1 L of water at 23±2° C., preferably lower than 10 mg in 1 L water, more preferably lower than 0.1 mg in 1 L of water, even more preferably less than 10 μg in 1 L water at 23±2° C.

According to the present invention, the microchannel in the microfluidic device of the present invention is at least partially coated with an intermediate layer directly applied to the material of the inner surface of said microchannel and the hydrophilic coating located on top of the intermediate layer. Thus, in one embodiment, the entire surface of the microchannel is coated with a combination of the intermediate layer and the hydrophilic coating.

In yet another embodiment, the inner surface of the microchannel is only partially coated. If the inner surface of the microchannel is only partially coated, it is preferred that the coated segment extends substantially along the entire microchannel. This design ensures that at any position of the microchannel, the aqueous biological sample is in contact with a surface coated with the hydrophobic material. Such arrangement ensures a particularly high reliability of the microfluidic device of the present invention.

The material of the intermediate layer may have a polar group which is neither a base nor a salt. The strength of adhesion of the hydrophilic coating, as measured by the stroke count in a wet scouring test, will be increased by at least two orders of magnitude, as compared with coatings of the prior art. The magnitude of increased adherence strength is as much as three to four orders of magnitude superior to the prior art in some embodiments of this invention.

The inventors further found that use of a non-swellable polymer having at least one polar group as a material of the intermediate layer allows a securely bonding of the hydrophilic coating of the aforementioned neutral or weakly anionic silicon and/or metallic oxide, to the surface of a hydrophobic material of the microchannel. The material of the intermediate layer must bind to two different components: the inner surface of the microchannel which is hydrophobic and the hydrophilic coating which is hydrophilic. While there are various polymer materials which adhere to a hydrophobic inner surface of the microchannel, adhesion to the hydrophilic coating is more difficult. It has now been surprisingly found that a non-swellable polymer layer having at least one polar group possesses these desirable characteristics of securely binding the silicon and/or metallic oxide to the surface of a hydrophobic inner surface of the microchannel.

In contrast to microfluidic devices of the prior art, where an undesired material swelling commonly causes a dysfunction of the fluid flow behaviour or even a channel blockage, the microfluidic devices of the present invention do not suffer from this drawback.

Furthermore and even more importantly, the above system has an excellent compatibility with biological samples, even with those containing alcohols, glycerides and hydrocarbons. No material swelling upon tests of the system was observed.

No undesired unspecific adsorption of cells, proteins and other components from the tested biological samples took place. As a consequence, the microchannels blockages cause by cell adsorption are avoided.

### The Hydrophilic Coating

Suitable materials for the hydrophilic coating are oxides, such as silicon dioxide and aluminium oxide, as well as oxide mixtures or mixed oxides. Advantageous, for example, are silicon-aluminium mixed oxides with a Si/Al ratio of from 1:1 to 30:1. They can be partially neutralized with a base and thus would contain a cation, such as an alkali or ammonium ion. The latter align very easily during drying. Anionically modified silicon dioxide and non-water-soluble metallic oxides are also useful.

Other metallic oxides, which can be contained in the hydrophilic coating in addition to, or instead of, silicon or aluminium oxide, can be derived from the elements, for example, of zinc, titanium, zirconium or chromium. Colourless metallic oxides are preferred, where colour is a factor. It is always a requirement that the oxides be practically insoluble in water. The solubility of the oxides per se or the hydrated form thereof, in water at 20° C., is preferably below 200 ppm.

The hydrophilic coating exerts a strong hydrophilic effect. This is apparently the result of both the good water wettability of the oxides as well as the sub-microscopic roughness of the oxide layer.

The metallic oxide can be applied from an aqueous colloidal suspension. However colloids in polar liquids, such as dimethyl formamide or isopropanol, or in aqueous solution mediums, such as mixtures of acetone, methanol or ethanol with water, can also be used. The colloidal state of course, is usually facilitated by the use of a suitable surfactant. The colloid particles have a size of less than 200 nm, and preferably less than 120 nm, particularly from 5 to 100 nm. The pure oxides are usually present in the colloid in more or less hydrated and neutralized forms, which can be used in the present invention in that form.

Colloidal silicic acid is commercially available in various useable preparations. Particularly suitable are anionic types which contain a cation, such as an alkali or ammonium ion, for stabilization. The products for forming the hydrophilic coating may be thermally curable or UV curable. An example of a suitable thermally curable commercial product is Kieselsol A200 (Bayer AG). Preferred UV curable products are for instance products from the Nanocryl® series (Evonik Industries AG).

The hydrophilic coating, aside from any potential surfactant content which may still be present, comprises primarily, more than 90% by weight, and preferably more than 99% by weight, of silicon oxide, metallic oxide or mixture thereof. The silicon oxide may be, e.g., silicon dioxide. It is preferable that there be no other components that are not water soluble. In any case, there must be a hydrophilic i.e. hydrophilic property which corresponds to a contact angle formation with a water droplet on the hydrophilic coating of less than 20°, and preferably less than 10°.

An additional important characteristic of the hydrophilic coating is its thickness. It has been found that the delamination tendency of the layer greatly increases with the thickness. Since with respect to the effectiveness of the layer, only its uninterrupted surface and not its thickness is of any significance, the thinnest possible layer that can be produced with the colloid employed will result in the best possible effect. Therefore, a layer thickness of from 0.01 to 4 μm, and particularly from 0.1 to 1 μm, is preferred.

### The Material of the Intermediate Layer

The material of the intermediate layer according to the present invention adheres to the hydrophilic coating and to the hydrophobic inner surface of the microchannel. If desired only a portion of the inner surface of the microchannel is provided with a hydrophilic coating. In this case the material of the intermediate layer may only be applied to those corresponding areas.

The important characteristic of the material of the intermediate layer is that it should be preferably a polymeric material having at least one polar group and must be insoluble and non-swellable. The polar groups do not have to be chemically bonded to the primary component of the material of the intermediate layer, although this is preferred. It is sufficient if the polar groups are chemically bonded to a secondary component. It is assumed that the adhesion arises through a reciprocal effect between the oxygen atoms or hydroxyl groups of the oxides and the polar groups. Since water molecules are also capable of a strong reciprocal effect with the oxide oxygen atoms and can displace the polar groups, the polymer material of the intermediate layer should absorb as little water as possible. In addition, the material of the intermediate layer strength would also be reduced through morphological changes as a result of repeated swelling and unswelling. This illuminates the significance of a reduced swellability together with a limited polarity, although the invention is not intended to be limited to a given theory.

The material of the intermediate layer typically consists of at least one polymeric or macromolecular substance having a gravimetric average molecular weight of more than 1000, and preferably more than 10,000. This can be an organic material having a comprehensive carbon framework or a carbon framework interrupted by oxygen or nitrogen atoms, or a mixed organic-inorganic material having a comprehensive basic framework comprised partially of heteroatoms such as oxygen and silicon.

The material of the intermediate layer preferably contains at least one polar group, particularly a hydroxyl, carboxyl, sulfonyl, carboxylic acid amide, nitrile or silanol group. The polar group is preferably a component of a macromolecular compound which simultaneously contains a non-polar group, such as an alkyl, alkylene, aryl or arylene group. The ratio of polar to non-polar groups must be selected such that adhesion is achieved both to the hydrophobic, i.e. non-polar inner surface of the microchannel as well as to the hydrophilic, i.e. hydrophilic coating. The polarity must not be so great that the material of the material of the intermediate layer itself is water-soluble or water-swellable. The swelling at saturation with water at 20° C. should not lie above 20% by volume, preferably not above 10% by volume and more preferably not above 2% by volume. On the other hand, the polarity must not be so low that the material becomes soluble in completely non-polar solvents, such as benzene. Most suitable are those which are soluble in organic solvents of restricted polarity, such as hydrocarbon chlorides, esters, ketones, alcohols or ethers or mixtures thereof with aromatic compounds. The material of the intermediate layer is itself, usually, not hydrophilic. Water droplets on its surface generally form a contact angle of more than 20, and more particularly, from 20° to 70°.

The necessary balancing of affinities to the two interfaces is generally achieved if the material of the intermediate layer contains from 0.4 to 100 polar groups milliequivalent for each 100 g of the material.

In a preferred embodiment of the present invention, the intermediate layer encompasses two polymers (A) and (B), where water forms a contact angle smaller than or equal to 73° on a layer of the polymer (A) at 23±2° C. and relative humidity 50±5%, and water forms a contact angle greater than or equal to 75° on a layer of the polymer (B). The contact angle can be determined at 23±2° C. and relative humidity 50±5%, using a Drop Shape Analyzer DSA100—standard contact angle measurement system from Krüss GmbH, Hamburg, Germany. Preferably, the contact angle is measured according to the norm DIN 55660 of December 2011 as described in detail below.

The layer thickness for determining the contact angle here is not significant, but the water is in contact only with a layer composed of the polymer (A) or, respectively, of the polymer (B). A layer thickness of 50 μm or less is generally sufficient. However, the layer should be smooth to permit correct determination of the contact angle. The values are applicable to a surface which is substantially smooth. The production of a surface of this type is known to the person skilled in the art. Given a sufficient layer thickness, a smooth surface forms spontaneously when a flow-coating process is used.

The important property of the intermediate layer is that its adhesion, both to the inner surface of the microchannel and to the layer which inhibits water droplet formation, is greater than that of the latter to the inner surface of the microchannel. While there are numerous organic polymer materials which adhere well to a hydrophobic inner surface of the microchannel, adequate adhesion to the layer which inhibits water droplet formation requires particular properties.

These properties are based on polymers (A) having polar groups and located in the intermediate layer, these polymers having low solubility and low swellability in water. The polarity of the polymers (A) is apparent by way of a low contact angle formed by water on a layer formed from polymers (A). This layer may comprise negligibly small amounts of additives or solvent residues, and it is essential here that these additives do not affect the contact angle. A layer of the polymer (A) therefore forms a contact angle smaller than or equal to 73° at 23±2° C. and relative humidity 50±5%, and the contact angle of the polymers (A) is preferably in the range from 50° to 72°, and particularly preferably in the range from 65° to 71°.

The nature of the polymer (A) is not subject to any particular restriction, as long as the polarity is present, this being reflected in the contact angle formed by water on a surface composed of polymer (A). This polarity may generally be achieved via polar groups which may be a constituent of the main chain and/or of side chains.

The polymer (A) may therefore be obtained by polyaddition or polycondensation reactions. Examples here are polyethers, polyesters, polycarbonates, polyurethanes, epoxy resins, polyamides, cycloolefin-copolymers (COC) and polystyrol (PS).

Polyvinyl compounds are another group of compounds suitable as polymer. Examples of these are polyolefins, such as polypropylene, polyethylene, polyaryl compounds, such as polystyrene; poly (alkyl)(meth)acrylates and polyvinyl acetates. Vinyl compounds suitable for preparing these polymers have been set out above.

In order that these polymers (A) have the contact angle set out above, these polymers may encompass polar groups. These groups may be incorporated into the polymer (A), by way of example, via the selection of suitable copolymers. These groups may moreover also be grafted onto a polymer by graft copolymerization.

Particular polar groups which may be mentioned are hydroxy, carboxy, sulphonyl, carboxamide, nitrile and silanol groups. They are preferably a constituent of a macromolecular compound which also contains non-polar groups, such as alkyl, alkylene, aryl or arylene groups.

The ratio of polar to non-polar groups in the polymers (A) has to be selected so as to achieve adhesion both to the hydrophobic, i.e. non-polar, inner surface of the microchannel, and also to the layer which inhibits water droplet formation, i.e. which is hydrophilic. The level of polarity must not be so high that the material of the intermediate layer itself is made water-soluble or water-swellable. The degree of swelling on saturation with water at 23±2° C. is not more than 10% by volume and preferably not more than 2% by volume. However, the level of polarity of the polymers (A) is also intended not to be so low that the material would be soluble in completely non-polar solvents, such as naphtha. Most of the suitable materials are soluble in organic solvents of modest polarity, such as chlorinated hydrocarbons, esters, ketones, alcohols or ethers, or mixtures of these with aromatics.

The required balance of affinities with the two adjacent layers is generally achieved if the material of the intermediate layer contains from 0.4 to 100 milliequivalents of polar groups in 100 g of the material.

Polar groups differ in their polarizing action. This increases in the sequence nitrile, hydroxy, primary carboxamide, carboxy, sulphonyl, silanol. The stronger the polarizing action, the lower the content required in the polymer material. Whereas from 4 to 100 milliequivalents of polar groups in 100 g of polymer material are used in the case of the low-polarity groups, from 0.4 to 20 milliequivalents/100 g of the high-polarity groups is sufficient. If the selected content of polar groups is too low, the layer which inhibits water droplet formation does not have sufficient adhesion. In contrast, if the content of polar groups is too high, the water-swellability increases excessively, and this in turn reduces adhesion.

The polarity of the polymers obtained by polycondensation or polyaddition, and encompassing hydroxy groups, may be increased, inter alia, by reaction with silanes which, per silicon atom, have at least two hydrolysable groups, such as halogen atom, alkoxy groups and/or aryloxy groups.

Examples of these compounds are tetraalkoxysilanes, such as tetramethoxysilane, tetraethoxysilane, trialkoxysilanes, such as methyltrimethoxysilane, methyltriethoxysilane, ethyltrimethoxysilane, n-propyltrimethoxysilane, n-propyltriethoxysilane, isopropyltriethoxysilane; dialkoxysilanes, such as dimethyldimethoxysilane, dimethyldiethoxysilane, diethyldimethyoxysilane, diethyldiethoxysilane, di-n-propyldimethoxysilane, di-n-propyldiethoxysilane, diisopropyldimethoxysilane, diisopropyldiethoxysilane.

The polymers which can be obtained by free-radical polymerization of vinyl compounds may also be modified, like the polymers which can be obtained by polycondensation or polyaddition.

To modify these polyvinyl compounds, use may in particular be made of silanes which encompass vinyl groups which are not hydrolysable. Examples of the particularly suitable vinylic silane compounds are

CH₂═CH—Si(OCH₃)₃, CH₂—CH—Si(OC₂H₅)₃, CH₂═CH—SiCl₃,

CH₂═CH—Si(CH₃)(OCH₃)₂, CH₂—CH—CO₂—C₃H₇—Si(OCH₃)₃,

CH₂—CH—CO₂—C₃H₇—Si(OCH₃)₃, CH₂—C(CH₃)—CO₂—C₃H₇—Si(OCH₃)₃,

CH₂—C(CH₃)—CO₂—C₃H₇—Si(OC₂H₅)₃ and CH₂—C(CH₃)CO₂ C₃H₇SiCl₃.

Preference is also given to polymers (A) which have groups which lead to crosslinking during and/or after the formation of the intermediate layer. Silanes having 3 hydrolysable groups and also one vinylic group are particularly suitable for this purpose, and examples of these silanes have been set out above.

The polar polymers (A) may be present either individually or as a mixture in the intermediate layer.

The amount of the polymer (A) in the intermediate layer (11) may be within a wide range. This is particularly dependent on the nature and the polarity of the polymer (B). The proportion is generally in the range from 30 to 95% by weight, preferably from 40 to 90% by weight, and particularly preferably from 50 to 85% by weight, based on the weight of the intermediate layer, but no resultant restriction is intended.

Besides the polar polymer (A), the intermediate layer (11) may encompass at least one polymer (B) which has non-polar properties. This property is reflected in the contact angle formed by water on a surface composed of polymers (B). This layer may comprise negligibly small amounts of additives or solvent residues, but it is essential that these additives do not affect the contact angle. The solubility of polymer (B) in water is very small. It is generally smaller than 1 g/l.

The nature of the polymer (B) is subject to no particular restriction, as long as the high level of hydrophobic properties is present, by way of the contact angle formed by water on a surface composed of polymer (B). A polymeric compound suitable as polymer (B) therefore has a high proportion of non-polar groups.

The hydrophobic properties of the polymers (B) are apparent by way of a large contact angle formed by water on a layer of the polymer (B). The contact angle found for a layer of the polymer (B) is therefore greater than or equal to 75°, and the contact angle of the polymers (B) is preferably in the range from 75° to 90° and particularly preferably in the range from 76° to 80°.

The polymer (B) may therefore be obtained by poly-addition or polycondensation reactions. Examples of these are polyethers, polyesters, polycarbonates, polyurethanes and polyamides.

Another group of compounds suitable as polymer (B) is that of polyvinyl compounds. Examples of these are polyolefins, such as polypropylene, polyethylene; polyaryl compounds, such as polystyrene; poly (alkyl)(meth)acrylates and polyvinyl acetates. Vinyl compounds suitable for preparing these polymers have been set out above.

To some extent, the abovementioned polymers encompass polar groups. This is non-critical, as long as the result of their polarity is not that the contact angle formed by water with a layer composed of polymer (B) lies outside the range given. It should be stated here that the polarity of these polymers can be reduced by hydrophobic side chains, such as alkyl chains, in such a way that the abovementioned contact angle values are achieved.

Preferred polymers (B) may be obtained by free-radical polymerization of mixtures which comprise the following constituents
(meth)acrylate 50-100% by weight
   methyl (meth)acrylate 0-60% by weight
      preferably 0-50% by weight
   ethyl (meth)acrylate 0-60% by weight
      preferably 0-50% by weight
   C3-C6 (meth)acrylate 0-100% by weight
   C7 (meth)acrylate 0-50% by weight
   polyfunctional (meth)acrylates 0-5% by weight
   comonomers 0-50% by weight
   vinylaromatics 0-30% by weight
   vinyl esters 0-30% by weight
based on the weight of the vinyl compounds.

The non-polar polymers (B) may be present individually or as a mixture in the intermediate layer (11).

The amount of the polymer (B) present in the intermediate layer (11) may be within a wide range. This depends particularly on the nature and the polarity of the polymer (B). The proportion is generally in the range from 5 to 70% by weight, preferably from 10 to 60% by weight and particularly preferably from 15 to 50% by weight, based on the weight of the intermediate layer, with no intended resultant restriction.

The intermediate layer may moreover comprise conventional additives. Particular examples of these are surfactants and flow control agents.

An example of a method for producing the intermediate layer uses mixing of polymer (A) and polymer (B) in a suitable solvent or dispersion medium to produce a coating mixture which may comprise the additives set out above. The use of solvent mixtures may be necessary, since the polymers (A) and (B) have differing polarity.

The coating mixtures set out above may be applied to the inner surface of the microchannel or to a film which later becomes a segment of the microchannel by any known method. Examples of these are immersion methods, spraying methods, doctoring, flow-coating methods, and application by rollers or by rolls.

The coatings thus applied can generally be hardened or dried in a relatively short time, for example within from 1 minute to 1 hour, generally within from about 3 minutes to 30 minutes, preferably within from about 5 minutes to 20 minutes, and at comparatively low temperatures, for example at from 70 to 110° C., preferably at about 80° C.

The coating can be applied onto the film in a particularly easy and cost-efficient manner by using roll-to-roll processing. Roll-to-roll manufacturing technique is well-known to the skilled person and involves a continuous processing of a film as it is transferred between two moving rolls in a continuous manner. In a preferred embodiment, the coating of the film with the intermediate layer takes place at a temperature ranging from 60° C. to 80° C. at a speed between 1 m/min to 70 m/min, more preferably between 10 m/min and 30 m/min.

Typically, curing of the intermediate layer and of the hydrophilic coating at a temperature ranging from 60° C. to 80° C. is substantially completed within a period between 1 min and 10 min, preferably between 2 min and 5 min. Therefore, the intermediate layer and the hydrophilic coating can be advantageously applied to the film surface in a single roll-to-roll line.

The thickness of the intermediate layer is not particularly critical. However, this is selected to be relatively low if possible, for reasons of cost-effectiveness, the lower limit being given by the stability of the entire coating. However, without any intended resultant restriction, the thickness of the intermediate layer after hardening is generally in the range from 0.05 μm to 10 μm, preferably from 0.1 μm to 2 μm, and particularly preferably from 0.2 μm to 1 μm. The layer thicknesses of the coatings can be determined by way of a transmission electron micrograph (TEM). It is important that the thickness of the intermediate layer is substantially uniform to ensure a high reliability of the microfluidic device of the present invention.

In one particular aspect of the present invention, the contact angle formed by water on the intermediate layer at 23±2° C. and relative humidity 50±5% is in the range from 63° to 80°, in particular in the range from 65° to 78° and particularly preferably in the range from 68° to 77°, with no resultant intended restriction.

After the drying of the intermediate layer, a hydrophilic coating is applied thereto.

It is also advantageous for the polymer material of the intermediate layer to be three dimensionally crosslinked (thermoset). In case the material of the intermediate layer is made from a solution of the polymer material, a crosslinking of this type may only be induced after the material of the intermediate layer has been formed. The crosslinking additionally reduces the swelling capacity and therefore increases reliability of the microfluidic device. It should not be so strong that the polymer material is completely hard and brittle. A certain elastic resiliency of the crosslinked polymer is advantageous.

A suitable class of said polymer materials comprises polymers or mixed polymers of vinyl monomers. At least a portion of the vinyl monomer units must include a polar group of the abovementioned type. It can originate from the original monomers or be introduced into the polymers by subsequent transfer. A portion of the vinyl monomers contains non-polar groups, such as alkyl, alkylene, aryl or arylene groups.

The polar groups differ in their polarizing effectiveness, which increases in the following order of progression: nitrile, hydroxyl, primary carboxylic acid amide, carboxyl, sulfonyl, and silanol. The stronger the polarizing effect, the lower is the required content of polymer material. While 4 to 100 polar groups milliequivalents per each 100 g of polymer material are used with the weak polar groups, 0.4 to 20 milliequivalents/100 g are sufficient for the strong polar groups. If the polar group content is selected too low, there will not be a satisfactory adhesion of the hydrophilic coating. If, in contrast, the polar group content is too high, the water-swelling capacity increases too much, which again reduces the adhesion.

Included among the vinyl monomers which carry the mentioned groups are, for example, acrylic and methacrylic nitrile, hydroxyalkyl esters of unsaturated polymerizable carboxylic acids, particularly those with 2 to 6 carbon atoms in the hydroxyalkyl residue, glycidyl acrylate, and methacrylate, or the dihydroxyalkyl esters produced therefrom through hydrolysis, the amides of the above-mentioned acids, particularly acrylic amide and methacrylic amide, acrylic acid, methacrylic acid, maleic acid, fumaric acid, or itaconic acid, as well as vinylsulphonic acid, styrenesulphonic acid, acrylic and methacrylic amidoalkanesulphonic acids, acryloxy and methacryloxyalkyl-trialkyl silanes and their products of hydrolysis. Polar groups that are neither bases nor salts are preferred, particularly hydroxyl, carboxyl, carbon amido and silanol groups.

Suitable vinylmonomers with non-polar groups are the alkyl esters of unsaturated, polymerizable acids, such as, for example, acrylic acid, methacrylic acid, maleic acid, fumaric acid or itaconic acid. The alkyl residues generally contain from 1 to 18 carbon atoms, preferably from 1 to 8 carbon atoms. Also suitable monomers are styrene, vinyl toluene, vinyl acetate, vinyl propionate and other vinyl esters of fatty acids, vinyl chloride, and vinylidene chloride.

Mixed polymers or copolymers of polar and non-polar vinyl monomers can be produced according to known methods of free radical polymerization, for example through solution or emulsion polymerization. The resulting solutions or dispersions can, if desired, after first being thinned, be directly employed to produce the material of the intermediate layer.

Other classes of suitable polymer materials for the material of the intermediate layer are polyesters, polyethers, polycarbonates, polyurethanes or epoxy resins having polar groups. The polar groups can be components of the original material employed or they can be introduced into the polymer material subsequently. Polymeric materials with hydroxyl groups, for example, can be converted with silanes, which carry at least two silicon-bonded halogen atoms, alkoxy groups or aryloxy groups. Suitable examples are tetrachlorosilane, tetraethoxysilane, tetraphenoxysilane, methyltrimethoxysilane or methyltrichlorosilane. Through hydrolysis of the thus introduced groups, perhaps after first forming the material of the intermediate layer, polar siloxane groups are formed. They have the advantage over the other polar groups that they exert a very strong bond to silicon and aluminum oxide and yet hardly affect the water-swelling capacity of the material of the intermediate layer. Therefore, polymer materials having Si—OH groups as an material of the intermediate layer represent a preferred embodiment of the invention. The effect of the material of the intermediate layer is achieved at both boundary surfaces; to the hydrophobic inner surface of the microchannel on one side and to the hydrophilic coating on the other side. To achieve this, the thinnest possible layer is desirable. The layer may therefore, be 0.01 to 20 μm and preferably only 0.01 to 2 μm in thickness. Thinner layers are difficult to produce with complete coverage. Thicker layers are less economical, but fully effective technically.

### Measurement of the Contact Angle

The contact angle can be determined at 23±2° C. and relative humidity 50±5%, using a Drop Shape Analyzer DSA100—standard contact angle measurement system from Krüss GmbH, Hamburg, Germany. A stainless needle such as NE62, available from Krüss GmbH can be employed.

Preferably, the contact angle is measured according to the norm DIN 55660 of December 2011 using the following procedure:

The sample to be analysed is placed horizontally on a planar support. The camera is positioned perpendicular to the surface of the sample upon using the prism system of the instrument. The viewing angle of the camera is adjusted depending on the expected contact angle.

Subsequently, the static contact angle is measured.

After aligning the needle tip and the sample table, the needle is turned upward and a water drop is formed on the tip of the needle. By lowering the needle, the drop is placed on the surface of the sample. The diameter of the drop is kept constant throughout the series of measurements and is ideally 2 mm. Between application of the drop and measuring the contact angle, a waiting time of 10 seconds is maintained.

Each contact angle measurement is carried out with a fresh drop. The contact angle is calculated as an average of 5 distinct measurements.

For determining surface free energy the Owens-Wendt method can be employed.

### The Coating Process

In one embodiment, the coating process according to the present invention can be performed directly following the manufacture of the microchannel element. In some cases however, for example during the coating of polyolefin plastics, a corona discharge treatment of the surface to be coated is useful prior to the application of the material of the intermediate layer.

In the preferred embodiment, the microfluidic device of the present invention comprises a film, at least one surface of which is coated with the intermediate layer covered by the hydrophilic layer. In this embodiment, the film is coated as described below and is subsequently employed for the manufacturing of the microfluidic device. This embodiment, alloys manufacturing of the microfluidic device in a particularly simple and cost-efficient manner.

The material of the intermediate layer can be applied as an aqueous dispersion or an organic solution of the coating agent. Where the layer is extremely thin the dispersion or solution can be applied in a highly thinned form. Concentrations of from 0.1% to 40% wt., preferably from 1 to 10% wt. are effective. The liquid coating agent can be applied by anilox rolls, by painting, pouring, rolling, spraying or any other known method. Preferably, the coating is applied using the roll-to-roll process or with anilox rolls. The applied coating liquid, if necessary, can be distributed uniformly with a doctor, for example a wire doctor, a toothed doctor, a rubber or an air doctor. Immediately after application, the liquid component is evaporated, for example in a warm air dryer. Subsequently, the oxide layer is applied in the same way. It is preferable that a colloidal, aqueous solution or dispersion of the oxide be applied. It is also possible, however, to apply a compound of silicon or other metal which is then hydrolyzed on the surface. For example, a solution of an orthosilicic acid ester can be applied in a weakly acidulated alcohol. The ester is hydrolyzed during or after the drying of the coating.

If the film is employed, it is important that the coating liquid achieves complete coverage of the treated surface. This can be facilitated if necessary by the addition of preferably non-ionic-surfactants. Suitable surfactants include, for example, oxyethylated fat alcohol in a concentration of from 2 to 20% by weight surfactant, relative to the oxide content, and preferably from 3 to 5% by weight. It is preferable that no more of the surfactant is used than is necessary for uniform wetting. The water is subsequently evaporated, again preferably in a warm air dryer. During the drying process the temperature in the coating generally does not climb above 50° C. to 60° C. The adhesion and resistance to being rubbed off are again noticeably improved if the dried coating is heated even further for a given period, for example, at least 3 minutes and preferably 5 to 10 minutes at more than 80° C. Depending on the type of inner surface of the microchannel or of the employed film, temperatures of more than 100° C. can be used, sometimes up to 150° C.

### The Material to be Coated

In one preferred embodiment, the microfluidic device 1 is composed of

an monolithic body 3 having at least one groove 4 on its surface and
a film 5 attached to said surface in such a way that the microchannel 2 is defined by the groove 4 in combination with the film 5,
the intermediate layer 11 is located on the surface of the film 5 adjacent to the monolithic body 3 and the hydrophilic coating 12 is located on top of the intermediate layer 11.

In this embodiment, the coatings 11 and 12 are first applied to the film 5. Good candidates for coating are attained with films of less than 10 mm thickness down to about 0.01 mm and preferably lying between 0.05 and 2 mm thickness. Particularly, goods results are attained with films of more than 0.1 mm thickness up to about 1 mm and preferably between 0.2 and 0.6 mm in thickness.

The material to be coated can be transparent, translucent or light-transmissible; preferably clear and colourless or translucent white.

In general, the coatings as described above are suitable for all plastics having inherently hydrophobic surfaces, such as primarily plastics which themselves contain no or only a negligible amount of polar groups in their structure. Included among these are, for example, polyethylene, polypropylene, polystyrene and its modified impact resistant derivatives, polyvinyl chloride and polyester. Such plastics are hydrophobic if the contact angle of a water droplet lying thereon is more than 70°.

Preferred plastics are polymethyl (meth)acrylates (acrylic glass) such as PMMA and polycarbonates, particularly that of bisphenol-A.

### Evaluation of the Hydrophilic Coating

Plastics, such a PMMA and polycarbonate, have a low solid body surface tension and are therefore difficult to wet with water. The contact angle of a water drop on the upper side of a horizontal, uncoated plate made from these plastics is about 75°. The contact angle is meant as the angle between the wetted surface and the tangent on the surface of the water drop at the point of contact with the surface. Preferably the contact angle is measured according to the norm DIN 55660 of December 2011.

Droplets with a contact angle of 75° almost form a complete hemisphere.

To evaluate the hydrophilic effect of various coated materials a box-like apparatus as described in EP 0 149 182 B1 can be employed (s. FIG. 1 of EP 0 149 182 B1). The depth is uniformly 230 mm; the side surfaces lying in front of and behind the sectional plane are closed. The floor of the apparatus is covered with a 150 mm deep layer of water which is held at a constant 40° C. by means of the heating elements 2.

The coated material to be tested forms the underside of a hollow chamber 4, through which water at 13° C. flows via the supply line 5 and the discharge line 6.

The glazing material 3 is arranged at an angle of 23°. If a hydrophilic coating is provided, it is located on the underside. The runoff condensation water is collected in a channel 7 and is led into a measuring container 9 through a line 8.

For evaluation, the quantity of water collected within 24 hours was measured. Since the quantity of condensation water should be practically equal in all tests, the deficiency in the collected water quantity from a poorly spreading glazing material relative to the water quantity of an optimally, spreading material represents the quantity of water that has dropped away. A thoroughly cleansed and degreased glass surface produces almost no drops and can be used as the optimal standard.

The results of the condensation water test are compiled for the tested glazing materials in the following Table 1.

TABLE 1

| | | Water spreading | Condensation water |
|---|---|---|---|
| Substrate | Adhesive layer | layer | quantity in ml/24 h |
| Silicate glass | none | none | 1400 |
| PMMA | none | none | 70 |
| Silicate glass | none | A | 1400 |
| PMMA | none | A | 650* |
| PMMA | none | B | 1400 |
| PMMA | M | C | 1400 |
| PMMA | M | D | 1400 |

Explanations:
*the water spreading layer was very effective at the beginning but separated after 12 hours
N adhesive layer made from a copolymer of butylmethacrylate, methylmethacrylate, alkylated methylolmethacrylic amide, hydroxyethylacrylate
M adhesive layer made from a copolymer of methylmethacrylate and methacryloxypropyltrimethoxysilane
A commercial waterspreading coating for silicate glass or plastic (Sunclear G. Solar Sunstill, USA)
B like A, but after drying period of 5 minutes at 80° C.
C commercial aqueous colloidal, slightly anionic silicic acid (Kieselsol A200, Bayer AG)
D commercial aqueous colloidal, slightly anionic, silicon dioxide modified on the surface with aluminum oxide, (Ludox AM, DuPont) or Nano acryl (Evonik Industries AG)

### Microfluidic Device of the Present Invention

After the material forming the entire inner surface of the microchannel or at least a segment of the inner surface of the microchannel has been coated as described above, the microfluidic device of the present invention can be assembled.

In a preferred embodiment, the microfluidic device of the present invention is composed of a monolithic body 3 having at least one groove on its surface and a film attached to said surface in such a way that the microchannel is defined by the groove in combination with the film. The surface of the film adjacent to the monolithic body 3 and forming a segment of the microchannel is coated with an intermediate layer located on the surface of the film which is, in turn, coated by the hydrophobic coating.

The cross-sectional area of microchannel 2 of the microfluidic device 1 is not particularly limited as long as a reliable flow of the sample is ensured. Preferably, the average cross-sectional area of the microchannel 2 is from 10 μm² to 4 mm², preferably from 40 μm² to 2 mm².

The shape of the cross-section of the microchannel is not particularly limited as long as it allows a reliable flow of the sample through the channel. In one embodiment, the microchannel has a substantially circular cross-section. However, as will be readily appreciated by skilled person, in the preferred embodiment of the present invention in which the microchannel is defined by the groove in combination with a film, at least the segment defined by the film surface is substantially planar. In this embodiment, the microchannel may have a rectangular cross section, a half circular cross-section, a triangular cross-section etc.

Thus, once the film is coated with the intermediate layer 11 and the hydrophilic coating 12, it is attached to the monolithic body 3 so that at least one microchannel 2 is formed.

A variety of techniques can be employed to fabricate the monolithic body 3, and the technique employed will be selected based in part on the material of choice. Exemplary materials for fabricating the monolithic body include glass, silicon, steel, nickel, PMMA, polycarbonate, polystyrene, polyethylene, polyolefins, silicones (e.g. poly (dimethylsiloxane), and combinations thereof. Other materials are known in the art. Methods for fabricating channels in these materials are known in the art. These methods include, photolithography (e.g. stereolithography or X-ray photolithography), moulding, embossing, silicon micromachining, wet or dry chemical etching, milling, diamond cutting, Lithographie Galvanoformung and Abformung (LIGA), and electroplating.

For example, for glass, traditional silicon fabrication techniques of photolithography followed by wet (KOH) or dry etching (reactive ion etching with fluorine or other reactive gas) can be employed. Techniques such as laser micromachining can be adopted for plastic materials with high photon absorption efficiency. This technique is suitable for lower throughput fabrication because of the serial nature of the process. For a particularly cost-efficient production of the monolithic body, thermoplastic injection moulding, and compression moulding is preferred. Conventional thermoplastic injection moulding used for mass-fabrication of compact discs (which preserves fidelity of features in sub-microns) may also be employed to fabricate the monolithic body for the microfluidic device.

For example, the shape of the monolithic body 3 are replicated on a glass master by conventional photolithography. The glass master is electroformed to yield a tough, thermal shock resistant, thermally conductive, hard mould. This mould serves as the master template for injection moulding or compression moulding the features into the monolithic body 3. Depending on the material used to fabricate the monolithic body and the requirements on optical quality and throughput of the finished microfluidic device, compression moulding or injection moulding may be chosen as the method of manufacture. Compression moulding (also called hot embossing or relief imprinting) has the advantages of being compatible with high-molecular weight polymers, which are excellent for small structures, but is difficult to use in replicating high aspect ratio structures and has longer cycle times. Injection moulding works well for high-aspect ratio structures but is most suitable for low molecular weight polymers.

In one embodiment, the monolithic body 3 is made of PMMA. The features are transferred onto an electroformed mould using standard photolithography followed by electroplating. The mould is used to hot emboss the features into the PMMA at a temperature near its glass transition temperature (105° C.) under pressure (5 to 20 tons) (pressure and temperature will be adjusted to account for high-fidelity replication of the deepest feature in the device). The mould is then cooled to enable removal of the monolithic body.

Subsequently, the coated film is applied to the monolithic body so that at least one microchannel is formed. The coated film may be bonded onto the surface of the monolithic body using vacuum-assisted thermal bonding. The vacuum prevents formation of air-gaps in the bonding regions.

The microfluidic device of the present invention may be fabricated by assembling a plurality of coated films and monolithic bodies. In one embodiment, separate films and monolithic bodies of the microfluidic device contain channels for a single fluid. Layers of a monolithic body may be bonded together and with the film by clamps, adhesives, heat, anodic bonding, or reactions between surface groups (e.g. wafer bonding).

In an alternative embodiment, the microfluidic device of the present invention in more than one plane may be fabricated as a single piece, e.g. using stereolithography or other three-dimensional fabrication techniques. The coating is then applied to the microchannels in a separate step.

In a further preferred embodiment, the microfluidic device 1 comprises at least
a first film 6 having at least one groove 4 on its surface and
a second film 5 attached to said surface of the first film 6 in such a way that the microchannel 2 is defined by the groove 4 in combination with the second film 5, wherein
the intermediate layer 11 is located on the surface of the film adjacent to the first film 6 and
the hydrophilic coating 12 is located on top of the intermediate layer 11.

In this embodiment, the microfluidic device 1 is typically manufactured by a process comprising
a step of attaching
a second film 5 having at least one surface which is least partially coated with
   an intermediate layer 11 directly applied to material 10 of the second film and
   an hydrophilic coating 12 located on top of the intermediate layer 11,
to a first film 6 having at least one groove 4 on its surface
in such a way that the microchannel 2 is defined by the groove 4 in combination with the second film 5.

The groove on the surface of the first film 6 may be formed by one of the methods described above in the context of the monolithic body 3. Alternatively, for the sake of an additional improvement of productivity and cost efficiency, the groove 4 on the surface of the first film 6 can be formed by hot embossing. A further advantageous possibility for building the groove 4 is laser etching. This method is particularly preferred when the microfluidic device 1 comprises a plurality of stacked films.

As will be readily appreciated by skilled person, the microfluidic device of the present invention may comprise more than two stacked films and/or monolithic bodies. This embodiment allows achieving a three-dimensional arrangement of microchannel and is therefore highly advantageous for building complex microfluidic devices having a high number of microchannels. In such arrangement, use of films having a hydrophilic coating on both sides is particularly advantageous because it allows forming microchannels on both sides of the film.

In yet a further embodiment, the first film 6 and the second film 5 both have at least one groove 4 on their surfaces. In this embodiment, the microchannels 2 may be defined by a combination of two grooves located on the surfaces of the first film 6 and the second film 5. This arrangement allows obtaining microchannels, which are entirely coated with the hydrophilic coating in a particularly simple way.

The invention is illustrated in more detail below by way of inventive examples and comparative examples, but there is no intention that the invention be restricted to these inventive examples.

### Example 1

### Preparation of the Intermediate Layer

A first copolymer composed of 88% of methyl methacrylate and 12% of γ-methacryloyloxypropyl-trimethoxysilane and a second copolymer composed of 20% of methyl methacrylate and 80% of butyl methacrylate were dissolved in a ratio of 1:1 in butyl acetate, and applied as a thin layer to PMMA films. After run-off, the coated film was dried in an oven at 80° C. for 20 min.

The contact angle of the dried intermediate layer with water was measured to be 76.5° at about 23° C. and relative humidity 50%. In contrast to this, the contact angle of an intermediate layer produced from the first copolymer was about 66° at 23° C. and relative humidity 50%, the methoxy groups of the γ-methacryloyloxypropyltrimethoxysilane having been hydrolysed to some extent. An intermediate layer composed of the second copolymer had a contact angle of 77.5°.

### Preparation of Hydrophilic Coating

25% of an anionic silica sol (solids content 30%), with 0.1% of the potassium salt of the 3-sulphopropyl ester of O-ethyldithiocarbonic acid and 0.4% of an ethoxylated fatty alcohol were made up to 100 parts with deionized water and coated in a thin layer onto the film provided with the intermediate layer.

After air-drying, the film provided with intermediate layer and with a hydrophilic coating is dried in a convection oven at 80° C. for 20 min.

After forming with a bending radius of 47.5 mm, the films produced as in Example 1 showed no cloudiness or cracks in the coating, and showed good inhibition of water droplet formation, with low contact angles.

The obtained film was directly used for the manufacturing of a microfluidic device of the present invention.

### Example 2

### Preparation of the Intermediate Layer

A 175 μm colourless film of polymethyl methacrylate manufactured by Evonik Industries AG was coated with at 22° C. and relative air humidity 35±2% with a commercially available product Acrifix® 120. The obtained coated film was dried for 10 min at room temperature, subsequently heated for 10 min at 80° C. and cooled to room temperature for 5 min.

### Preparation of Hydrophilic Coating

Subsequently, the commercially available product Acrifix® 122 was applied onto the intermediate layer at room temperature. The coated film was dried for 10 min at room temperature, subsequently heated for 10 min at 80° C. and cooled to room temperature for 5 min.

The obtained film was used in a microfluidic device of the present invention.

### Example 3

A film of extruded polymethylmethacrylate was covered on one surface by means of a wire doctor with a 4 μm thick film of a 2.5% solution of a mixed polymer comprising 47% by weight butylmethacrylate, 47% by weight methylmethacrylate, 3% by weight of an alkylated N-methylol methacrylic amide and 3% by weight hydroxyethylacrylate in a mixture of isopropyl alcohol and toluene. The mixed polymer contains 26 polar group milliequivalent/100 g. After drying the polymer layer is 0.1 μm thick. It is heated for 5 min. at 80° C. and after cooling covered with a 12 μm thick layer of a 3%, slightly anionic aqueous silicic sol (commercial product Ludox AM, DuPont) modified at the surface with aluminum oxide, which sol contains 0.01% by weight of an 8× oxethylated isotridecylic alcohol as a non-ionic emulsifying agent. The still-wet coating is dried for 5 minutes in an ambient air heating cabinet at 80° C. The resulting SiO2 layer has a thickness of 0.15 μm.

A water drop placed on the flat-lying coating spreads until it forms an contact angle of less than 10°.

The coated film was employed for the manufacturing of a microfluidic device and the device was tested with various biological samples.

### Example 4

The method according to Example 3 was repeated, except that the intermediate layer was made from a mixed polymer of 47% by weight butylmethacrylate, 47% by weight methylmethacrylate, 3% by weight glycidylmethacrylate and 3% by weight methacrylic acid. With the assumption of a complete exchange of the glycidyl groups with the carboxyl groups of the methacrylic acid, the layer contains, for each 100 g of polymer, 21 of hydroxyl milliequivalents and 14 carboxyl groups milliequivalents, which corresponds to a total of 35 milliequivalents/100 g for polar groups. The hydrophilic coating was applied as in Example 3.

The contact angle of a water droplet placed on the layer was less than 10°.

The coated film was employed for the manufacturing of a microfluidic device and the device was tested with various biological samples.

### Example 5

The method according to Example 3 was repeated, except that the intermediate layer was produced from a mixed polymer of 87.6% by weight methylmethacrylate and 12.4% by weight γ-methacryloxypropyl-trimethoxysilane. After hydrolysis of the siloxane groups it contains 50 milliequivalents/100 g of polar silanol groups.

The contact angle of a water drop placed on the coating was less than 10°.

### Example 6

The method according to Example 3 was repeated, except that the intermediate layer was produced from a mixed polymer of 85.6% by weight methylmethacrylate, 12.4% by weight γ-methacryloxypropyl-trimethoxysilane and 2% by weight N-butoxymethylmethacrylamide. After hydrolysis of the siloxane groups, it contains 50 milliequivalents/100 g of polar silanol groups.

The contact angle of a water drop placed on the coating was less than 10°.

### Examples 7-10

The coating method according to Examples 3-6 was repeated with the exception that a different, slightly anionic, aqueous silicic sol (commercial product Kieselsol A200, Bayer AG) was employed in the same concentration.

1. A microfluidic device comprising a microchannel,
wherein the microchannel comprises an inner surface,
wherein the inner surface is at least partially coated with
an intermediate layer disposed directly on a material of the inner surface, and
a hydrophilic coating disposed on the intermediate layer,
wherein the hydrophilic coating consists of a hydrophilic material,
wherein the material of the inner surface is a hydrophobic material, and
wherein the hydrophilic material, the hydrophobic material and a material of the intermediate layer are substantially insoluble in water.

2. The microfluidic device of claim 1, wherein the hydrophilic material comprises colloid particles of at least one selected from the group consisting of a silicon oxide, a metallic oxide and a mixture thereof.

3. The microfluidic device of claim 1, wherein the material of the intermediate layer comprises a polymer comprising at least one polar group selected from the group consisting of a nitrile group, a hydroxyl group, a primary carboxylic acid amide group, a carboxyl group, a sulfonyl group, and a silanol group.

4. The microfluidic device of claim 1, wherein the hydrophobic material comprises a cycloolefin copolymer, a polyethylene terephthalate, a polycarbonate, a poly(alkyl)(meth)acrylate or a mixture thereof.

5. The microfluidic device of claim 1, wherein an average cross-sectional area of the microchannel is in a range of 10 μm² to 4 mm².

6. The microfluidic device of claim 1, wherein the microfluidic device comprises:
a monolithic body comprising a surface comprising a groove, and
a film,
wherein the film is attached to the surface of the monolithic body,
wherein the film and the groove form the microchannel,
wherein the intermediate layer is disposed on a surface of the film,
wherein the surface of the film is adjacent to the monolithic body, and
wherein the hydrophilic coating is disposed on the intermediate layer.

7. The microfluidic device of claim 1, wherein the microfluidic device comprises:
a first film comprising a surface comprising a groove, and
a second film,
wherein the second film is attached to the surface of the first film,
wherein the second film and the groove form the microchannel,
wherein the intermediate layer is disposed on a surface of the second film,
wherein the surface of the second film is adjacent to the first film, and
wherein the hydrophilic coating is disposed on the intermediate layer.

8. The microfluidic device of claim 6, wherein a thickness of the film is in a range of 0.05 mm to 10 mm.

9. The microfluidic device of claim 1, wherein a thickness of the intermediate layer is in a range of 0.05 μm to 2.0 μm and/or a thickness of the hydrophilic coating is in a range of 0.01 μm to 4.0 μm.

10. The microfluidic device of claim 1, wherein the intermediate layer comprises a polymer (A) and a polymer (B),
wherein the polymer (A) has a contact angle with water of less than or equal to 73° at 23±2° C. and a relative humidity of 50±5%, and
wherein the polymer (B) has a contact angle with water of greater than or equal to 75° at 23±2° C. and a relative humidity of 50±5%.

11. The microfluidic device of claim 10, wherein the intermediate layer comprises:
the polymer (A) in a range of 30 to 95% by weight, based on a total weight of the intermediate layer; and/or
the polymer (B) in a range of 5 to 70% by weight, based on the total weight of the intermediate layer.

12. The microfluidic device of claim 1, wherein the hydrophilic coating is obtained by a process comprising:
curing at least one colloidal solution comprising at least one compound selected from the group consisting of an inorganic compound and an organometallic compound, and/or
condensing a composition comprising at least 80% by weight of at least one selected from the group consisting of an alkyltrialkoxysilane and tetraalkoxysilane, based on a content of condensable silanes.

13. The microfluidic device of claim 1, wherein the hydrophilic coating comprises a condensable polysiloxane having a molar mass in a range of 500 to 1,500 g/mol.

14. The microfluidic device of claim 6, wherein the film consists of a hydrophobic material.

15. A process for manufacturing a microfluidic device comprising a microchannel, the process comprising:
(i) attaching a film comprising a surface to a surface of a monolithic body, the surface of the monolithic body comprising a groove, to form the microchannel,
wherein the surface of the film is at least partially coated with
an intermediate layer disposed directly on the film, and
a hydrophilic coating disposed on the intermediate layer,
wherein the surface of the film is adjacent to the monolithic body,
wherein the hydrophilic coating consists of a hydrophilic material,
wherein a material of the film consists of a hydrophobic material, and
wherein the hydrophilic material, the hydrophobic material and a material of the intermediate layer are substantially insoluble in water, or
(ii) attaching a second film comprising a surface to a first film comprising a surface comprising a groove, to form the microchannel,
wherein the surface of the second film is at least partially coated with
an intermediate layer disposed directly on the second film, and
a hydrophilic coating disposed on the intermediate layer,
wherein the hydrophilic coating consists of a hydrophilic material,
wherein a material of the second film consists of a hydrophobic material, and
wherein the hydrophilic material, the hydrophobic material and a material of the intermediate layer are substantially insoluble in water.

16. The microfluidic device of claim 7, wherein a thickness of the first film is in a range of 0.05 mm to 10 mm and a thickness of the second film is in a range of 0.05 mm to 10 mm.
